(19) United States
(12) Patent Application Publication
(10) Pub. No.: US 2008/0291055 A1
(43) Pub. Date: Nov. 27, 2008

(54) METHOD AND SYSTEM FOR VEHICLE TRAFFIC MONITORING BASED ON THE DETECTION OF A CHARACTERISTIC RADIO FREQUENCY

(76) Inventor: Nathan J. Harrington, Cary, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/752,713

(22) Filed: May 23, 2007

(51) Int. Cl. G08G 1/01

(52) U.S. Cl. 340/933

(57) ABSTRACT

A method of vehicle traffic monitoring based on the detection of characteristic Radio Frequency (RF) emissions. A detector detects RF pulses on multiple frequencies emitted by ignition sparks in a combustion chamber of a motor vehicle within a detection zone. When RF pulses occur on different frequencies simultaneously, the detector increments a count of ignition events within a first pre-defined time window. When the first time window elapses, the detector transmits the count to a central monitoring station. The central station calculates an average change within a second pre-defined time window and updates a running average. When a difference between the count and the running average is greater than a pre-defined congestion threshold, the central station sets a traffic state to “free flowing”. When the difference between the count and the running average is not greater than the pre-defined congestion threshold, the central station sets the traffic state to “congested”.

### BACKGROUND OF THE INVENTION

1. Technical Field

The present invention relates in general to motor vehicles and in particular to traffic monitoring systems. Still more particularly, the present invention relates to an improved method and system for vehicle traffic monitoring based on the detection of characteristic Radio Frequency (RF) emissions.

2. Description of the Related Art

Conventional vehicle traffic monitoring systems utilize various mechanical and/or electrical sensors (e.g., pneumatic tube sensors, inductive loop sensors, electromagnetic wave reflection/beam break sensors, impedance mismatch detectors, video processing devices, and road noise sensors) to detect the presence of vehicles in one or more lanes of a roadway. Sensors must typically be placed precisely to reliably detect the presence of vehicles across multiple lane positions. Furthermore, conventional traffic monitoring systems may also require the installation of multiple sensor devices on multi-lane roadways (e.g., one inductive loop for each lane).

Conventional vehicle traffic monitoring systems require large investments in data communication infrastructure and physical support systems. Some sensors, such as inductive loop sensors and impedance mismatch detectors, require modifications to the road surface that necessitate extensive physical labor and traffic disruptions during installation. Inductive loop and impedance mismatch sensors can not easily discern between singular large metallic masses connected to one motive force (e.g., an 18 wheeler truck) and multiple closely-spaced vehicles. Other sensors, such as video processing devices and laser sensors, require an unobstructed line of sight, thereby necessitating relatively high altitude installations (e.g., antenna masts or towers). Line of sight sensors may also operate inaccurately at night or in adverse weather conditions.

### SUMMARY OF AN EMBODIMENT

Disclosed are a method, system, and computer storage medium for vehicle traffic monitoring based on the detection of characteristic Radio Frequency (RF) emissions. An RF detector detects multiple RF pulses on multiple frequencies emitted by ignition sparks in a combustion chamber of a motor vehicle within a detection zone. When multiple RF pulses occur on different frequencies simultaneously, the detector increments a current count of ignition events within a first pre-defined time window. When the first pre-defined time window has elapsed, the detector transmits the current count of ignition events to a central monitoring station. The central monitoring station calculates an average change of the current count of ignition events within a second pre-defined time window and updates a running average. When a difference between the current count of ignition events and the running average is greater than a pre-defined congestion threshold, the central monitoring station sets a traffic state corresponding to the detection zone to a “free flowing” value. When the difference between the current count of ignition events and the running average is not greater than the pre-defined congestion threshold, the central monitoring station sets the traffic state corresponding to the detection zone to a “congested” value.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level schematic diagram of a Radio Frequency (RF) vehicle detector, according to an embodiment of the present invention;

FIG. 2 illustrates a high level block diagram of an exemplary vehicle traffic monitoring system, according to an embodiment of the present invention;

FIG. 3 is a high level logical flowchart of an exemplary method of monitoring traffic based on the detection of characteristic RF emissions, according to an embodiment of the invention; and

FIG. 4 is a high level logical flowchart of an exemplary method of utilizing the vehicle traffic monitoring system of FIG. 2 to determine the congestion level of traffic, according to an embodiment of the invention.

### DETAILED DESCRIPTION OF AN ILLUSTRATIVE EMBODIMENT

The present invention provides a method, system, and computer storage medium for vehicle traffic monitoring based on the detection of characteristic Radio Frequency (RF) emissions.

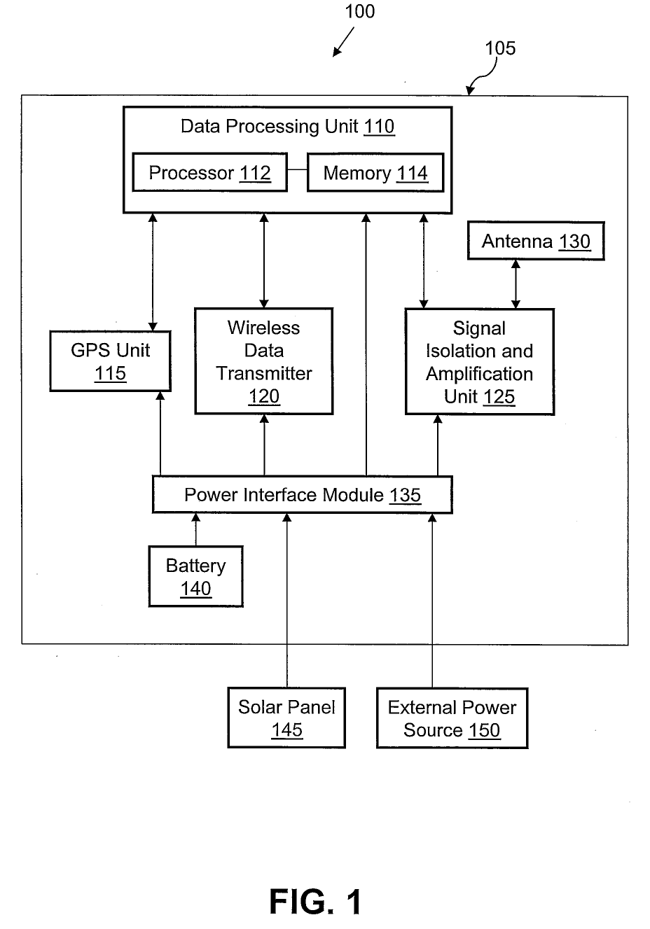

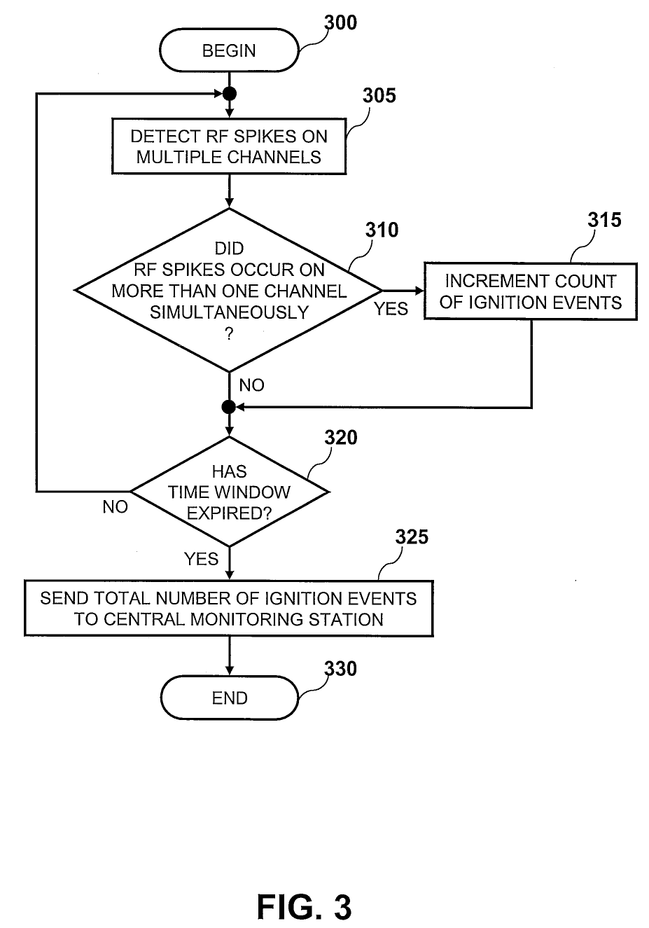

With reference now to FIG. 1, there is depicted a high level schematic diagram of a RF vehicle detector, according to an embodiment of the present invention. As shown, the electrical components of detector 100 are included within a weather proof case 105. In one embodiment, case 105 is transparent to RF energy, and an antenna 130 and/or a wireless data transmitter 120 are included inside the physical boundaries of case 105. Detector 100 also includes a data processing unit 110. Data processing unit 110 includes a processor 112 and a memory 114. Data processing unit 110 performs the functions illustrated in FIG. 3, which is discussed below.

According to the illustrative embodiment, detector 100 also includes a Global Positioning System (GPS) unit 115, a wireless data transmitter 120, a signal isolation and amplification unit 125, a power interface module 135, and a battery 140, all of which are preferably located inside case 105. GPS unit 115 is coupled to data processing unit 110 and information to processing unit 110 that corresponds to the geographic location of detector 100. GPS unit 115 receives power from power interface module 135, which is in turn connected to battery 140. Power interface module 135 provides Direct Current (DC) and/or Alternating Current (AC) to GPS unit 115, wireless data transmitter 120, data processing unit 110, and signal isolation and amplification unit 125. In one embodiment, power interface module 135 is connected to a solar panel 145 and an external power source 150 (e.g., a municipal power line). In another embodiment, power interface module 135 may enable solar panel 145 to recharge battery 140.

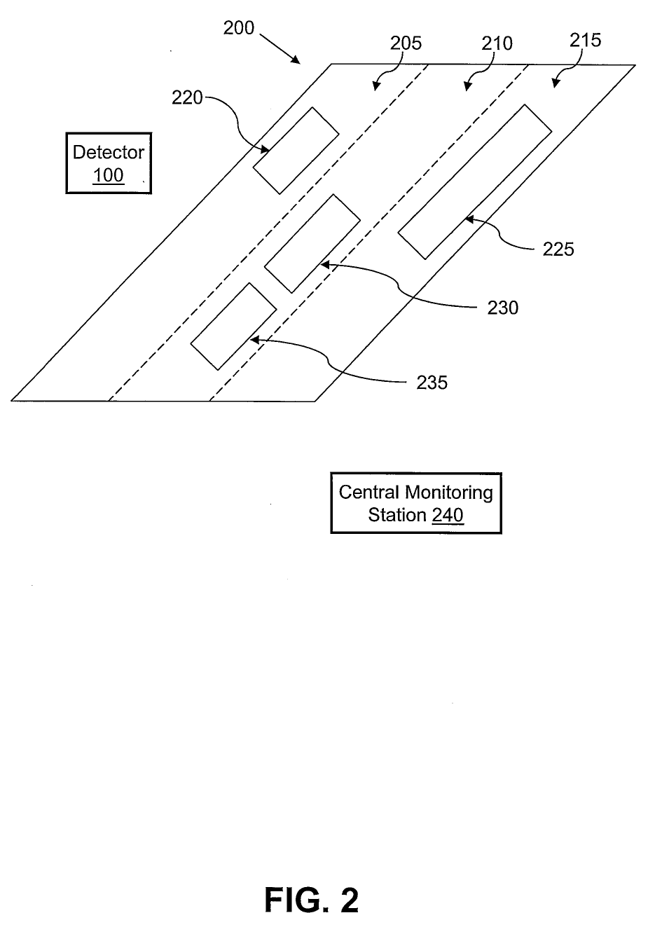

Wireless data transmitter 120 is coupled to data processing unit 110. Wireless data transmitter 120 transmits location and traffic data to a central monitoring station, as illustrated in FIG. 2, which is discussed below. Wireless data transmitter may be a satellite phone modem, a General Packet Radio Service (GPRS) network cellular modem, an Enhanced Data Rates for Global system for mobile communications Evolution (EDGE) network cellular modem, or the like.

Antenna 130 is coupled to signal isolation and amplification unit 125, which is coupled to data processing unit 110. Antenna 130 detects characteristic RF emissions from one or more vehicles that are equipped with internal combustion engines and spark plug ignition systems (e.g., cars, trucks, and motorcycles). When electrical sparks jump between electrodes in the combustion chamber of an engine (i.e., when spark plugs fire), the sparks emit RF energy at one or more characteristic frequencies. In one embodiment, the characteristic frequencies correspond to multiple points on the electromagnetic spectrum between 30 kHz and 30 MHz, including, but not limited to, the frequencies of 30 kHz, 999 kHz, 15 MHz, and 30 MHz. Antenna 130 detects the RF emissions and passes the signals to signal isolation and amplification unit 125, which filters out interference, such as white noise and telecommunications signals at similar frequencies, and subsequently amplifies the spark gap RF emissions prior to sending the RF signals to data processing unit 110. Data processing unit 110 utilizes the detected RF signals to develop a count of ignition events over a pre-defined time window via the process illustrated in FIG. 3, which is discussed below. In one embodiment, data processing unit 110 may compare the count of ignition events to one or more pre-defined known properties corresponding to different engines (e.g., typical ignition rates of 4 cylinder, 6 cylinder, and 8 cylinder engines) and/or engine manufacturers (e.g., Chevrolet, Ford, Honda, and Toyota) to calculate the Revolutions Per Minute (RPM) of an engine.

With reference now to FIG. 2, there is depicted a high level block diagram of an exemplary vehicle traffic monitoring system, according to an embodiment of the present invention. As illustrated in FIG. 1, which is described above, detector 100 may determine the general location and engine RPM of one or more vehicles within a specific detection zone 200. As shown, detection zone 200 includes a portion of a roadway that includes multiple lanes, including, but not limited to, a first lane 205, a second lane 210, and a third lane 215. Detector 100 is located on one side of the roadway within range of detection zone 200 (e.g., at a safe distance adjacent to the shoulder of the roadway). Detector 100 does not require precise positioning or line of sight positioning. Furthermore, detector 100 does not require installation beneath the surface of the roadway or any modifications to the surface of the roadway. Detection zone 200 can include one or more roadway surfaces (e.g., dirt, gravel, asphalt, or concrete). In another embodiment, detection zone 200 may also include multiple shoulders and/or medians.

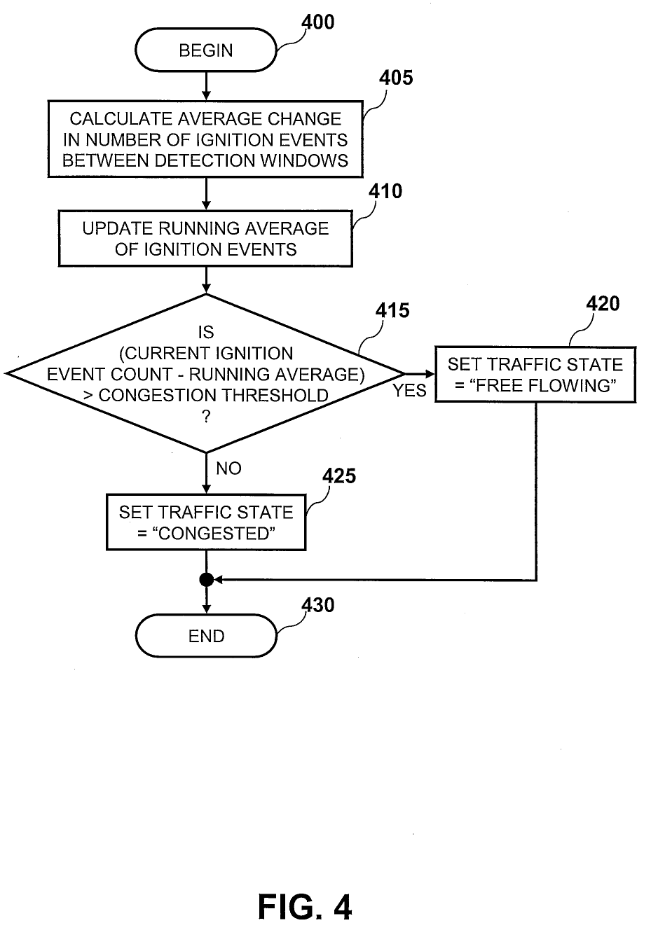

Each lane within detection zone 200 may include multiple moving and/or stationary motor vehicles. According to the illustrative embodiment, first lane 205 includes a first car 220. Similarly, second lane 210 includes a motorcycle 235 and a second car 230. Third lane 215 includes a truck 225. Detector 100 is placed within range of detection zone 200 and a central monitoring station 240. Central monitoring station 240 is configured similarly to detector 100, and may receive input from multiple detectors. In one embodiment, detector 100 periodically transmits a count of ignition events that have occurred within detection zone 200 to central monitoring station 240 for processing. Central monitoring station 240 utilizes the count of ignition events to determine whether or not the traffic within detection zone 200 is congested via the process illustrated in FIG. 4, which is discussed below.

With reference now to FIG. 3, there is illustrated a high level logical flowchart of an exemplary method of monitoring traffic based on the detection of characteristic RF emissions, according to an embodiment of the invention. The process begins at block 300 in response to detector 100 detecting an RF spike. As utilized herein, an RF spike refers to a pulse of RF energy emitted at a characteristic frequency between 30 kHz and 30 MHz. An RF spike may thus be caused by an ignition event or an external signal (e.g., a telecommunications signal). As utilized herein, an ignition event is defined as an RF spike that occurs simultaneously on multiple discrete frequencies between 30 kHz and 30 MHz when an electrical spark occurs in the combustion chamber of a motor vehicle engine. An ignition event thus has an RF signature that includes multiple discrete simultaneous RF spikes on different frequencies, while an external interference signal typically has an RF signature that includes one or more RF spikes on a single frequency. In another embodiment, an ignition event may also be defined as a pulse of RF energy emitted by any vehicle-borne electromagnetic device, including, but not limited to, an electromagnetic fuel injector control device, a fuel pump, an auxiliary heating/cooling device, or an actuating motor (e.g., a windshield wiper motor).

Detector 100 monitors and detects RF spikes on multiple channels (i.e., a frequency band), as depicted in block 305. Detector 100 monitors multiple frequencies to reduce the potential effects of interference from telecommunications devices using one or more particular frequencies. Data processing unit 110 determines whether RF spikes occurred on more than one channel (i.e., frequency) simultaneously, as shown in block 310. If RF spikes occurred on more than one channel simultaneously, data processing unit 110 increments a count of ignition events and stores the updated count within memory 114, as depicted in block 315. The process then proceeds to block 320. If multiple RF spikes caused by an ignition event occur at the same instant as an RF spike caused by an external telecommunications signal on one of the monitored frequencies, data processing unit 110 thus still recognizes the overall ignition event. If RF spikes did not occur on more than one channel simultaneously, the process proceeds to block 320.

At block 320, data processing unit 110 determines whether the pre-defined time window has elapsed. In one embodiment, the pre-defined time window may be a short time period (e.g., 1 second). In another embodiment, the pre-defined time window may instead be defined by a user of detector 100 and/or central monitoring station 240. If the pre-defined time window has not expired, the process returns to block 305 and detector 100 continues to monitor and count ignition events. If the pre-defined time window has expired, data processing unit 110 utilizes wireless data transmitter 120 to send the current total number of ignition events to central monitoring station 240, as depicted in block 325, and the process terminates at block 330.

Turning now to FIG. 4, there is illustrated a high level logical flowchart of an exemplary method of utilizing the vehicle traffic monitoring system of FIG. 2 to determine the congestion level of traffic, according to an embodiment of the invention. The process begins at block 400 in response to central monitoring station 240 receiving information from detector 100 that corresponds to a count of ignition events. Central monitoring station 240 calculates the average change in the number of ignition events between the periodic detection time windows of a detector (e.g., detector 100), as depicted in block 405. Central monitoring station 240 subsequently updates a running average of ignition events for a detector over a second pre-defined longer time window (e.g., 6 seconds), as shown in block 410, and the process proceeds to block 415.

At block 415, central monitoring station 240 determines whether the difference between the current ignition event count and the running average for a detector is greater than a pre-defined congestion threshold. In a “free flowing” (i.e., non-congested) detection zone, the traffic flow and thus the number of ignition events will vary over the course of many sampling windows. However in a “congested” detection zone, the traffic flow will remain relatively constant over the course of many sampling windows. If the difference between the current ignition event count and the running average for a detector is greater than the pre-defined congestion threshold (i.e., traffic flow is currently varying between detection windows), central monitoring station 240 sets the traffic state of the detection zone that corresponds to the detector (e.g., detection zone 200 for detector 100) to a “free flowing” state, as depicted in block 420, and the process terminates at block 430. If the difference between the current ignition event count and the running average for a detector is less than the pre-defined congestion threshold (i.e., traffic flow is relatively constant between detection windows), central monitoring station 240 sets the traffic state of the detection zone that corresponds to the detector to a “congested” state, as shown in block 425, and the process terminates at block 430. In another embodiment, detector 100 may instead calculate the state of the traffic in detection zone 200 locally, and detector 100 may subsequently transmit the calculated state of the traffic (i.e., congested or free flowing) to central monitoring station 240.

The present invention thus provides a method of vehicle traffic monitoring based on the detection of characteristic RF emissions. Detector 100 detects multiple RF pulses on multiple frequencies emitted by ignition sparks in a combustion chamber of a motor vehicle within detection zone 200. When multiple RF pulses occur on different frequencies simultaneously, detector 100 increments a current count of ignition events within a first pre-defined time window. When the first pre-defined time window has elapsed, detector 100 transmits the current count of ignition events to central monitoring station 240. Central monitoring station 240 calculates an average change of the current count of ignition events within a second pre-defined time window and updates a running average. When a difference between the current count of ignition events and the running average is greater than a pre-defined congestion threshold, central monitoring station 240 sets a traffic state corresponding to detection zone 200 to a “free flowing” value. When the difference between the current count of ignition events and the running average is not greater than the pre-defined congestion threshold, central monitoring station 140 sets the traffic state corresponding to the detection zone to a “congested” value.

It is understood that the use herein of specific names are for example only and not meant to imply any limitations on the invention. The invention may thus be implemented with different nomenclature/terminology and associated functionality utilized to describe the above devices/utility, etc., without limitation.

In the flow charts (FIGS. 3 and 4) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional data processing system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
detecting a plurality of radio frequency (RF) pulses on a plurality of frequencies within a detection zone, wherein said plurality of RF pulses are emitted by a plurality of ignition sparks in a combustion chamber of a motor vehicle;
in response to a determination that said plurality of RF pulses occurred on said plurality of frequencies simultaneously, incrementing a current count of ignition events within a first pre-defined time window;
in response to a determination that said first pre-defined time window has elapsed, transmitting said current count of ignition events to a central monitoring station;
calculating an average change of said current count of ignition events in said detection zone within a second pre-defined time window;
updating a running average with said average change of said count of ignition events within said second pre-defined time window;
in response to a determination that a difference between said current count of ignition events and said running average is greater than a pre-defined congestion threshold, setting a traffic state that corresponds to said detection zone to a “free flowing” value; and
in response to a determination that said difference between said current count of ignition events and said running average is not greater than said pre-defined congestion threshold, setting said traffic state that corresponds to said detection zone to a “congested” value.

2. The method of claim 1, wherein said plurality of RF pulses are emitted by an electromagnetic device in said motor vehicle.

3. The method of claim 1, further comprising transmitting said traffic state to said central monitoring station.

4. A vehicle monitoring system comprising:
a central monitoring station;
a radio frequency (RF) detector, wherein said RF detector includes:
a data processing unit that includes a processor and a memory;
a global positioning system (GPS) unit coupled to said data processing unit;
a wireless data transmitter coupled to said data processing unit, wherein said wireless data transmitter enables said data processing unit to communicate with said central monitoring station;
an antenna capable of detecting a plurality of RF pulses on a plurality of frequencies within a detection zone, wherein said plurality of RF pulses are emitted by a plurality of ignition sparks in a combustion chamber of a motor vehicle;
a signal isolation and amplification unit coupled to said antenna and said data processing unit;
a power interface module;
a battery coupled to said power interface module; and
a solar panel coupled to said power interface module;
means for incrementing a current count of ignition events within a first pre-defined time window in response to a determination that said plurality of RF pulses occurred on said plurality of frequencies simultaneously;
means for calculating an average change of said current count of ignition events in said detection zone within a second pre-defined time window;
means for updating a running average with said average change of said count of ignition events within said second pre-defined time window;
means for setting a traffic state that corresponds to said detection zone to a “free flowing” value in response to a determination that a difference between said current count of ignition events and said running average is greater than a pre-defined congestion threshold; and
means for setting said traffic state that corresponds to said detection zone to a “congested” value in response to a determination that said difference between said current count of ignition events and said running average is not greater than said pre-defined congestion threshold.

5. The vehicle monitoring system of claim 4, wherein said plurality of RF pulses are emitted by an electromagnetic device in said motor vehicle.

6. A computer storage medium encoded with a computer program that, when executed, performs the steps of:
detecting a plurality of radio frequency (RF) pulses on a plurality of frequencies within a detection zone, wherein said plurality of RF pulses are emitted by a plurality of ignition sparks in a combustion chamber of a motor vehicle;
in response to a determination that said plurality of RF pulses occurred on said plurality of frequencies simultaneously, incrementing a current count of ignition events within a first pre-defined time window;
in response to a determination that said first pre-defined time window has elapsed, transmitting said current count of ignition events to a central monitoring station;
calculating an average change of said current count of ignition events in said detection zone within a second pre-defined time window;
updating a running average with said average change of said count of ignition events within said second pre-defined time window;
in response to a determination that a difference between said current count of ignition events and said running average is greater than a pre-defined congestion threshold, setting a traffic state that corresponds to said detection zone to a “free flowing” value; and
in response to a determination that said difference between said current count of ignition events and said running average is not greater than said pre-defined congestion threshold, setting said traffic state that corresponds to said detection zone to a “congested” value.
